(19) United States
(12) Patent Application Publication
(10) Pub. No.: US 2007/0251736 A1
(43) Pub. Date: Nov. 1, 2007

(54) Hydrostatic-electric drive

(75) Inventors: Martin Bergmann, Schaafheim (DE); Bernward Welschof, Grossostheim (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Material Handling GmbH & Co. KG, Aschaffenburg (DE)

(21) Appl. No.: 11/715,282

(22) Filed: Mar. 7, 2007

(30) Foreign Application Priority Data
Mar. 10, 2006 (DE) 10 2006 011 167.2

(51) Int. Cl. B60K 25/00

(52) U.S. Cl. 180/53.4

(57) ABSTRACT

A hydrostatic-electric drive has an internal combustion engine, a pump driven by the internal combustion engine and located together with at least one hydromotor in a hydraulic circuit, an electric energy storage device, and an electric motor which is connected to the energy storage device and which can be placed in active connection with the hydraulic circuit. The pump is located in a drive connection with the electric motor parallel to the internal combustion engine.

### CROSS REFERENCE TO RELATED APPLICATION

This application claims priority to German Application No. 10 2006 011 167.2, filed Mar. 10, 2006, which application is herein incorporated by reference in its entirety.

### BACKGROUND OF THE INVENTION

1. Field of the Invention

This invention relates to a hydrostatic-electric drive with an internal combustion engine, a pump that is driven by the engine and is located together with at least one hydromotor in a hydraulic circuit, an electrical energy storage device, and an electric motor that is connected to the energy storage device and can be brought into an active connection with the hydraulic circuit.

2. Technical Considerations

A hydrostatic-electric drive is described in DE 35 01 608 A1. On this drive, which is a traction drive, the hydraulic circuit has a primary drive train and a secondary drive train. The primary drive train consists of the pump driven by the internal combustion engine and the hydromotor which is connected to the pump via hydraulic lines. Connected to the hydraulic lines of the primary drive train are hydraulic lines of a secondary drive train that is connected in parallel and contains a second pump which can be driven by the electric motor. The electric motor is supplied with energy from a battery which is charged by a generator that is connected to the internal combustion engine.

It is an object of the invention to provide a drive of the general type described above but that has a more simplified construction.

### SUMMARY OF THE INVENTION

The above object can be accomplished by providing a hydrostatic-electric drive in which the pump is in a drive connection with the electric motor that is parallel to the internal combustion engine.

In one aspect of the invention, the electric motor is not brought into an active connection with the hydraulic circuit by means of a separate pump but, rather, the pump that is already present in the hydraulic circuit is used for this purpose, i.e., this pump is driven both by the internal combustion engine as well as, in parallel operation, by the electric motor.

Consequently, a smaller internal combustion engine can be used, for example one that operates in the optimum efficiency range and has a low fuel consumption. The known characteristics of hydrostatic drives, such as uninterrupted traction, good control capabilities, etc., are retained and can be utilized to achieve a low energy consumption under all load conditions by the hydrostatic-electric drive of the invention.

In one particularly advantageous development of the invention, the electric motor can be operated as a generator and the electric energy generated can be fed into the energy storage device. Energy can therefore be fed back from the consumer side into the energy storage device, for example during deceleration processes or during the lowering of loads, depending on the purpose for which the hydrostatic-electric drive of the invention is being used. The energy storage device can be, for example, in the form of batteries, capacitors, and/or an electric flywheel energy storage device used individually or in combination with one another.

The internal combustion engine, the pump, and the electric motor can be advantageously arranged coaxially with one another, which results in a space-saving construction.

In this case, the pump can be located between the internal combustion engine and the electric motor. For the parallel supply of energy into the pump, the two ends of a drive shaft that runs through the pump can be connected in a torque-transmitting connection with the internal combustion engine and the electric motor respectively.

If the electric motor and the pump are located in a common housing, the circulating hydraulic fluid can be used for cooling of the electric motor. It is thereby possible to operate the electric motor at high electric current densities and to reduce the space occupied by the equipment.

These advantages can also be achieved in an additional configuration if the electric motor and a booster pump are located in a common housing. The booster pump can be present, for example, for a hydraulic work system or for a hydraulic steering system.

In one development of the invention, a clutch or a freewheel mechanism can be connected between the internal combustion engine and the pump. The internal combustion engine can thereby be temporarily turned off or operated at idle, to make it possible, for example, to operate the hydrostatic-electric drive in environments in which no exhaust emissions or only low exhaust emissions are permitted.

### BRIEF DESCRIPTION OF THE DRAWINGS

Additional advantages and details of the invention are described in greater detail below and are illustrated schematically in the accompanying figures, in which:

FIG. 1 is a schematic diagram of a hydrostatic-electric drive of the invention;

FIG. 2 shows a first variant of the drive of FIG. 1; and

FIG. 3 shows a second variant of the drive of FIG. 1.

### DESCRIPTION OF THE PREFERRED EMBODIMENT

In the illustrated exemplary embodiments, the hydrostatic-electric drive of the invention is depicted in the form of a traction drive and has an internal combustion engine 1 which is coupled with a pump 2 (for example a variable displacement pump), which is hydraulically connected via hydraulic lines 3, 4 with two hydromotors 6, 7 that are located in a drive axle 5. In the illustrated embodiment, the hydromotors 6, 7 are constant displacement motors, although variable displacement motors can also be used. In this embodiment, the pump 2 and the hydromotors 6, 7 are located in a closed hydraulic circuit. It goes without saying that instead of or in addition to a traction drive, any other type of hydrostatic consumer can also be present.

The internal combustion engine 1 is supplied with fuel from a tank 8 and can be realized, for example, in the form of a diesel engine. Naturally, any other suitable type of thermal engine, e.g., a gas turbine, can also be used.

Parallel to the internal combustion engine 1, the pump 2 can be driven by an electric motor 9 which is supplied from an electrical storage device 10 (e.g., a battery and/or capacitor and/or electrical flywheel energy storage device, just to name a few). In this exemplary embodiment, the internal combustion engine 1, the pump 2 and the electric motor 9 are arranged coaxially with one another, whereby the pump 2 is located between the internal combustion engine 1 and the electric motor 9. The pump 2 advantageously can have a continuous drive shaft, the ends of which are coupled with the internal combustion engine 1 and/or the electric motor 9.

Because the internal combustion engine 1 does not drive the pump 2 by itself, but operates it in parallel with the electric motor 9, it is possible to make the internal combustion engine 1 smaller than in known hydrostatic-electric drives. This simplifies the construction process and reduces fuel consumption, in addition to the fact that a smaller internal combustion engine is generally more efficient.

The electric motor 9 can also be operated as a generator. In this case, for example, when a vehicle equipped with the traction drive of the invention is traveling downhill or during braking, energy is fed via the hydraulic circuit into the pump 2, which therefore operates as a hydromotor and drives the electric motor 9 regeneratively. The energy thereby recovered by the electric motor 9 is fed into the electric energy storage device 10, although the electric energy storage device 10 can also be supplied from external energy sources (as illustrated by the dashed line 20).

To make temporary emission-free or low-emission operation possible, a mechanism 22, such as a clutch or a freewheel mechanism, can be connected between the pump 2 and the internal combustion engine 1.

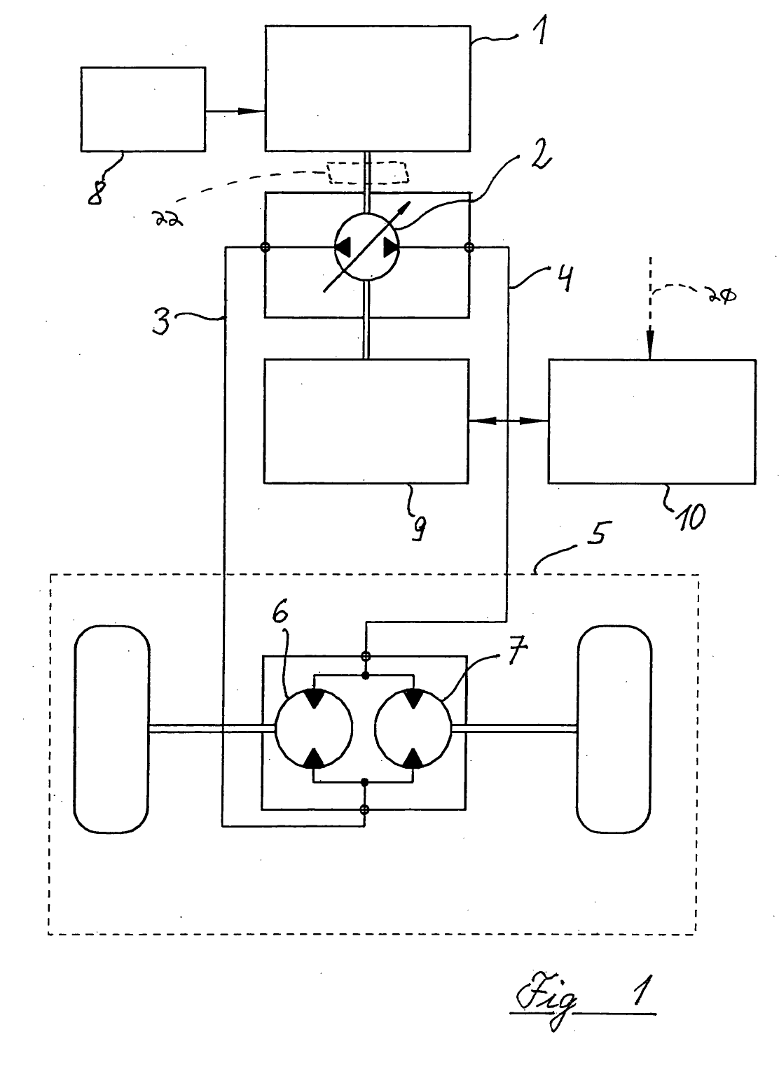

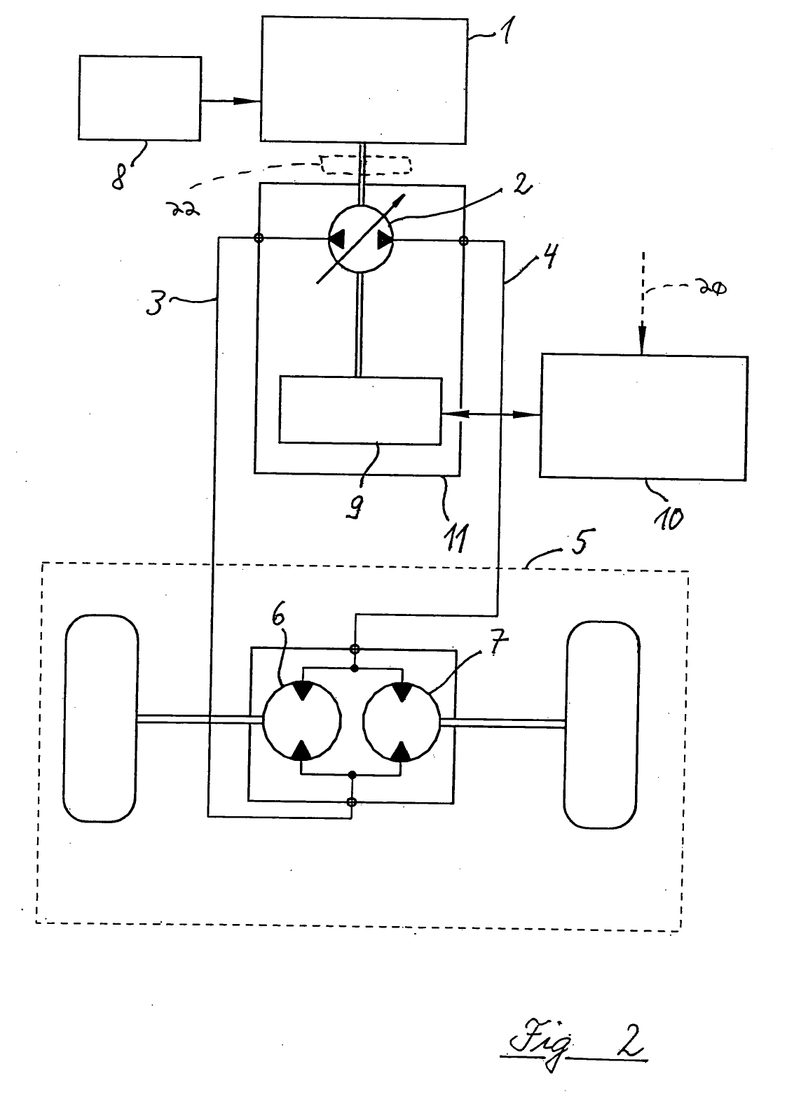

The variant of the hydrostatic-electric drive of the invention illustrated in FIG. 2 differs from the variant illustrated in FIG. 1 in that the pump 2 and the electric motor 9 are located in a common housing 11. The electric motor 9 can therefore be cooled by hydraulic fluid, which makes possible a higher current density and a smaller size of the drive.

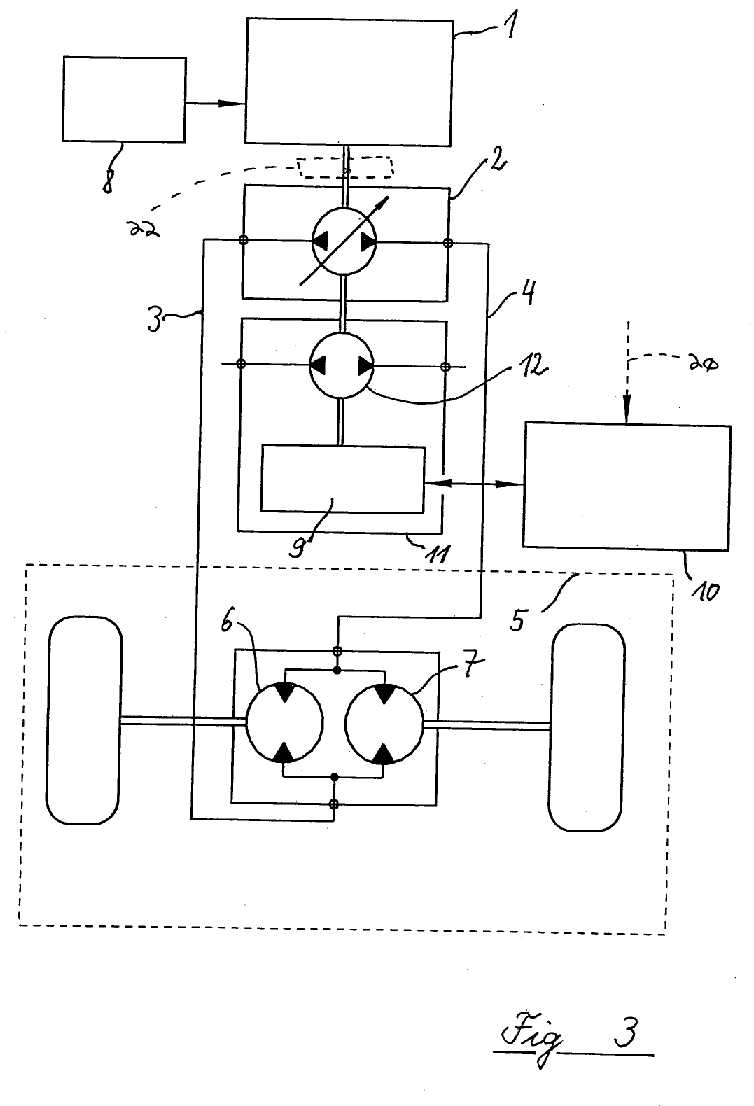

In the variant illustrated in FIG. 3, the pump 2 is coupled with a booster pump 12 which in turn is connected with the electric motor 9. The booster pump 12 and the electric motor 9 are located in a common housing 11, so that here, too, the electric motor 9 is cooled by hydraulic fluid.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A hydrostatic-electric drive, comprising:
an internal combustion engine;
a pump driven by the internal combustion engine and located together with at least one hydromotor in a hydraulic circuit;
an electric energy storage device; and
an electric motor connected to the energy storage device, wherein the electric motor can be placed in active connection with the hydraulic circuit, and wherein the pump is in a drive connection with the electric motor parallel to the internal combustion engine.

2. The hydrostatic-electric drive of claim 1, wherein the electric motor can be operated as a generator and electric energy produced thereby can be fed into the energy storage device.

3. The hydrostatic-electric drive of claim 1, wherein the internal combustion engine, the pump, and the electric motor are arranged coaxially next to one another.

4. The hydrostatic-electric drive of claim 3, wherein the pump is located between the internal combustion engine and the electric motor.

5. The hydrostatic-electric drive of claim 1, wherein the electric motor and the pump are located in a common housing.

6. The hydrostatic-electric drive of claim 1, further comprising a booster pump, with the electric motor and the booster pump being located in a common housing.

7. The hydrostatic-electric drive of claim 1, further comprising a clutch or a freewheel mechanism connected between the internal combustion engine and the pump.

8. The hydrostatic-electric drive of claim 2, wherein the internal combustion engine, the pump, and the electric motor are arranged coaxially next to one another.

9. The hydrostatic-electric drive of claim 8, wherein the pump is located between the internal combustion engine and the electric motor.

10. The hydrostatic-electric drive of claim 2, wherein the electric motor and the pump are located in a common housing.

11. The hydrostatic-electric drive of claim 3, wherein the electric motor and the pump are located in a common housing.

12. The hydrostatic-electric drive of claim 4, wherein the electric motor and the pump are located in a common housing.

13. The hydrostatic-electric drive of claim 2, further comprising a booster pump, with the electric motor and the booster pump being located in a common housing.

14. The hydrostatic-electric drive of claim 3, further comprising a booster pump, with the electric motor and the booster pump being located in a common housing.

15. The hydrostatic-electric drive of claim 4, further comprising a booster pump, with the electric motor and the booster pump being located in a common housing.

16. The hydrostatic-electric drive of claim 5, further comprising a booster pump, with the electric motor and the booster pump being located in a common housing.

17. The hydrostatic-electric drive of claim 2, further comprising a clutch or a freewheel mechanism connected between the internal combustion engine and the pump.

18. The hydrostatic-electric drive of claim 3, further comprising a clutch or a freewheel mechanism connected between the internal combustion engine and the pump.

19. The hydrostatic-electric drive of claim 4, further comprising a clutch or a freewheel mechanism connected between the internal combustion engine and the pump.

20. The hydrostatic-electric drive of claim 5, further comprising a clutch or a freewheel mechanism connected between the internal combustion engine and the pump.
